(19) United States
(12) Patent Application Publication
(10) Pub. No.: US 2007/0195390 A1
(43) Pub. Date: Aug. 23, 2007

(54) Holographic Recording Method And Holographic Recording Apparatus

(75) Inventors: Takuya Tsukagoshi, Kanagawa (JP); Tetsuro Mizushima, Oosaka (JP); Jiro Yoshinari, Tokyo (JP); Hideaki Miura, Tokyo (JP)

Correspondence Address: OLIFF & BERRIDGE, PLC, P.O. BOX 19928, ALEXANDRIA, VA, 22320, US

(73) Assignee: TDK CORPORATION, TOKYO (JP)

(21) Appl. No.: 11/578,330

(22) PCT Filed: Apr. 1, 2005
(86) PCT No.: PCT/JP05/06508

§ 371 Date: Oct. 13, 2006

(30) Foreign Application Priority Data
Apr. 20, 2004 (JP) 2004-124679

(51) Int. Cl. G02B 5/32

(52) U.S. Cl. 359/15

(57) ABSTRACT

A holographic recording method and a holographic recording apparatus which can provide a shortened time for recording and an improved data rate during recording even when the recording material has a low photosensitivity or the light source has a low power. This is achieved by, before a minimum exposure time for forming a reproducible hologram is reached, completing an interference exposure using signal light and reference light to form an incomplete hologram; performing an independent exposure for irradiating the incomplete hologram with the reference light after the interference exposure to thereby produce diffracted light; and recording information by means of interference between the reference light and the diffracted light.

### TECHNICAL FIELD

The present invention relates to a holographic recording method and a holographic recording apparatus.

### BACKGROUND ART

Conventionally, a holographic recording method is widely known in which laser light is split into signal light and reference light to employ interference fringes therebetween for recording information as a hologram (e.g., see Japanese Patent Laid-Open Publication No. 2000-242157).

The recording speed of such holographic recording (or data rate during recording) is subject to constraints such as the photosensitivity of a recording material and the light source power of a recording system.

However, in a conventional holographic recording method, a lower photosensitivity of a recording material or a lower light source power of a recording system requires a longer exposure time of the recording material and a larger amount of light exposure, thereby imposing limitations on improvement in data rate during recording.

### DISCLOSURE OF THE INVENTION

The present invention has been devised in order to solve such a problem. It is therefore an object of the present invention to provide a holographic recording method and a holographic recording apparatus which can provide a shortened time for recording and an improved data rate during recording even when the recording material has a low photosensitivity or the light source has a low power.

As a result of intensive studies, the inventor of the present invention has found a holographic recording method and a holographic recording apparatus which can provide a shortened time for recording and an improved data rate during recording even when the recording material has a low photosensitivity or the light source has a low power.

In summary, the above-described objectives are achieved by the following aspects of the present invention.

(1) A holographic recording method for recording information in a recording layer as a hologram by means of interference fringes between signal light and reference light branched out from laser light, the method comprising: before a minimum exposure time for forming a reproducible hologram is reached, completing an interference exposure using the signal light and the reference light to form an incomplete hologram; performing an independent exposure for irradiating the incomplete hologram with the reference light after the interference exposure to thereby produce diffracted light; and recording the information by means of interference between the reference light and the diffracted light.

(2) A holographic recording method for recording information in a recording layer as a hologram by means of interference fringes between signal light and reference light branched out from laser light, the method comprising: before a minimum exposure time for forming a reproducible hologram is reached, completing an interference exposure using the signal light and the reference light to form an incomplete hologram; performing an independent exposure for irradiating the incomplete hologram with amplified light after the interference exposure to thereby produce the diffracted light, the amplified light being different from the reference light and having the same incidence angle as that of the reference light; and the interference between the amplified light and the diffracted light is used to record the information.

(3) The holographic recording method according to (2), wherein when a plurality of the holograms are sequentially recorded, a plurality of beams of amplified light are used to perform the independent exposures in parallel on a plurality of the incomplete holograms.

(4) The holographic recording method according to (3), wherein the incomplete holograms are subjected to independent exposure with an exposure time which is decreased in an order in which the incomplete holograms are recorded.

(5) The holographic recording method according to (3) or

(4), wherein the plurality of beams of amplified light are incapable of producing interference with each other.

(6) The holographic recording method according to any one of (3) to (5), wherein a light source of the plurality of beams of amplified light is formed of either a laser array having a plurality of laser diodes or a surface emission laser diode.

(7) The holographic recording method according to any one of (3) to (5), wherein the interference exposure is performed in a predetermined area in the recording layer, and along with the interference exposure, the independent exposure is performed in another area where the incomplete hologram is present.

(8) A holographic recording apparatus capable of recording information in a recording layer as a hologram by means of interference fringes between signal light and reference light branched out from laser light, the holographic recording apparatus comprising a signal optical system and a reference optical system, in which before a minimum exposure time for forming a reproducible hologram is reached, an interference exposure is completed using the signal light and the reference light to form an incomplete hologram; an independent exposure for irradiating the incomplete hologram with the reference light is performed after the interference exposure to thereby produce diffracted light; and a intensity of the incomplete hologram can be amplified by means of interference between the reference light and the diffracted light.

(9) A holographic recording apparatus capable of recording information in a recording layer as a hologram by means of interference fringes between signal light and reference light branched out from laser light, the holographic recording apparatus comprising a signal optical system and a reference optical system, in which before a minimum exposure time for forming a reproducible hologram is reached, an interference exposure is completed using the signal light and the reference light to form an incomplete hologram; and an amplification optical system capable of performing the independent exposure by irradiating the incomplete hologram with amplified light after the interference exposure to thereby produce diffracted light, the amplified light being different from the reference light and having the same incidence angle as that of the reference light; and using the interference between the amplified light and the diffracted light to amplify a intensity of the incomplete hologram.

(10) The holographic recording apparatus according to (9), wherein when a plurality of the holograms are sequentially recorded, a plurality of beams of amplified light are used to perform the independent exposures in parallel on a plurality of the incomplete holograms.

(11) The holographic recording apparatus according to (10), wherein the amplification optical system is comprised so that the incomplete holograms are subjected to independent exposure with an exposure time which is decreased in an order in which the incomplete holograms are recorded.

(12) The holographic recording apparatus according (10) or (11), wherein the plurality of beams of amplified light are incapable of producing interference with each other.

(13) The holographic recording apparatus according to any one of (10) to (12), wherein a light source of the plurality of beams of amplified light is formed of either a laser array having a plurality of laser diodes or a surface emission laser diode.

(14) The holographic recording apparatus according to of (9) to (13), wherein the signal optical system and the reference optical system are used to perform the interference exposure in a predetermined area in the recording layer, and along with the interference exposure, the amplification optical system is used to perform the independent exposure in another area in which the incomplete hologram is present.

### BRIEF DESCRIPTION OF THE DRAWINGS

FIG. 1 is an optical system diagram of a holographic recording apparatus according to a first embodiment of the present invention.

FIG. 2 is a graph for showing the relationship between the exposure time during recording and the refractive index modulation factor in a conventional holographic recording apparatus.

FIG. 3 is a graph for showing the relationship between the exposure time during recording and the refractive index modulation factor in a holographic recording apparatus according to the first embodiment of the present invention.

FIG. 4 is a schematic side view showing the relationship between reference light and signal light in the holographic recording apparatus.

FIG. 5 is an optical system diagram of a holographic recording apparatus according to a second embodiment of the present invention.

FIG. 6 is a schematic side view showing the relationship between reference light and signal light in the holographic recording apparatus.

FIG. 7 is a graph for showing the relationship between the exposure time during recording and the refractive index modulation factor in the holographic recording apparatus.

FIG. 8 is an optical system diagram of a holographic recording apparatus according to a third embodiment of the present invention.

FIG. 9 is a schematic plan view illustrating an LD array in the holographic recording apparatus.

FIG. 10 is a graph for showing an example of controlling the interference exposure and the independent exposure in the holographic recording apparatus.

FIG. 11 is a graph for showing another example of controlling the interference exposure and the independent exposure in the holographic recording apparatus.

FIG. 12 is a graph for showing still another example of controlling the interference exposure and the independent exposure in the holographic recording apparatus.

FIG. 13 is an optical system diagram of a holographic recording apparatus according to a fourth embodiment of the present invention.

FIG. 14 is a schematic side view illustrating how to perform the interference exposure and the independent exposure in the holographic recording apparatus.

### BEST MODE FOR CARRYING OUT THE INVENTION

The holographic recording method according to the present invention is a holographic recording method for recording information in a recording layer as a hologram by means of interference fringes between signal light and reference light branched out from laser light, the method comprising: before a minimum exposure time for forming a reproducible hologram is reached, completing an interference exposure using the signal light and the reference light to form an incomplete hologram; performing an independent exposure for irradiating the incomplete hologram with the reference light after the interference exposure to thereby produce diffracted light; and recording the information by means of interference between the reference light and the diffracted light, thereby solving the forgoing problems.

Furthermore, The holographic recording method according to the present invention is a holographic recording method for recording information in a recording layer as a hologram by means of interference fringes between signal light and reference light branched out from laser light, the method comprising: before a minimum exposure time for forming a reproducible hologram is reached, completing an interference exposure using the signal light and the reference light to form an incomplete hologram; performing an independent exposure for irradiating the incomplete hologram with amplified light after the interference exposure to thereby produce diffracted light, the amplified light being different from the reference light but having the same incidence angle as that of the reference light; and recording the information by means of interference between the amplified light and the diffracted light, thereby solving the forgoing problems.

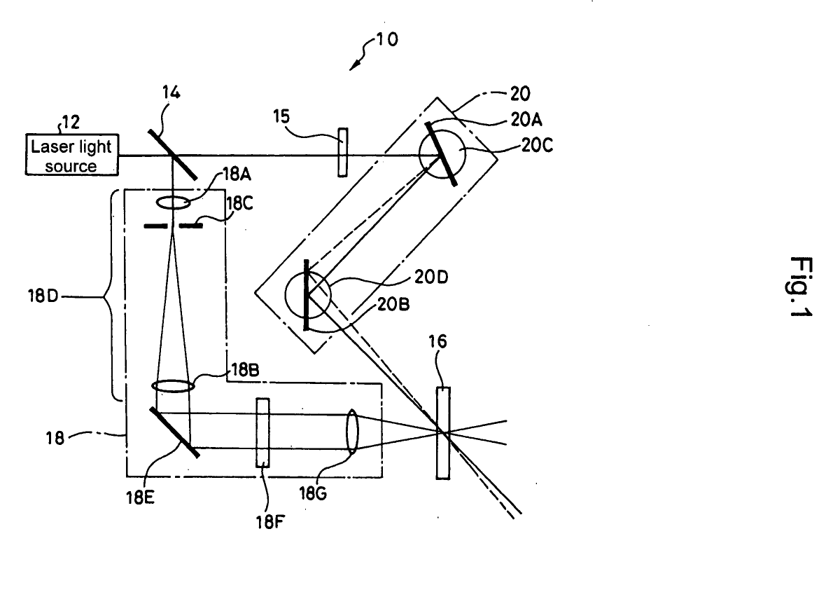

With reference to FIGS. 1 to 14, descriptions will be given of a holographic recording method and a holographic recording apparatus according to first to fourth embodiments of the present invention.

### FIRST EMBODIMENT

To begin with, a holographic recording method according to a first embodiment will be described using a holographic recording apparatus 10 as shown in FIG. 1.

The holographic recording apparatus 10 is configured to include: a laser light source 12; a polarizing beam splitter 14 for transmitting either one of linearly-polarized beams of laser light from this laser light source 12 which have orthogonal planes of vibration, such as a p-polarized component, and reflecting an s-polarized component; a signal optical system 18 for introducing the s-polarized signal light reflected from this polarizing beam splitter 14 to a holographic recording medium 16; and a reference optical system 20 for introducing s-polarized reference light to the holographic recording medium 16, the reference light being transmitted through the polarizing beam splitter 14 as p-polarized before its plane of vibration is rotated generally 90° by a half-wave plate 15.

The signal optical system 18 is configured to include: a beam expander 18D for expanding the beam diameter of the signal light emitted from the laser light source 12, consisting of two first and second lenses 18A and 18B and a pin hole 18C; a mirror 18E for reflecting the signal light past this beam expander 18D at a right angle; a spatial light modulator (hereinafter, SLM) 18F on which the signal light reflected from the mirror 18E is incident; and a Fourier lens 18G for condensing the signal light past this SLM 18F to inside the holographic recording medium 16.

The reference optical system 20 is configured to include two rotary mirrors 20A and 20B for reflecting the reference light incident thereon from the polarization beam splitter 14 to the holographic recording medium 16. Note that the rotary mirrors 20A and 20B are supported by rotary stages 20C and 20D to provide adjustable angles of reflection, thereby allowing the reference optical system 20 to modulate the incidence angle of the reference light on the holographic recording medium 16.

In the holographic recording method according to the first embodiment, an “interference exposure” is completed using signal light and reference light before a minimum exposure time for forming a reproducible hologram is reached to form an incomplete hologram; an “independent exposure” for irradiating the incomplete hologram with the reference light is performed after the interference exposure to thereby produce diffracted light; and an interference between the reference light and its diffracted light is used to amplify the intensity of the incomplete hologram. Now, an explanation will be made to the aforementioned “interference exposure.”

In the interference exposure according to the first embodiment, the holographic recording medium 16 is irradiated with both signal light and reference light branched out from laser light.

More specifically, the signal light having entered the signal optical system 18 is expanded in beam diameter by the beam expander 18D, then reflected by the mirror 18E, then provided with data in the form of intensity modulation by the SLM 18F, and then condensed and Fourier transformed in the intensity distribution by the Fourier lens 18G, to irradiate the holographic recording medium 16 with.

On the other hand, the reference light having entered the reference optical system 20 is reflected by the two rotary mirrors 20A and 20B at predetermined angles and then crosses the irradiating signal light in the holographic recording medium 16.

These signal and reference light cause optical interference in the area where they meet, which is in turn recorded as an incomplete hologram on the holographic recording medium 16, as described later.

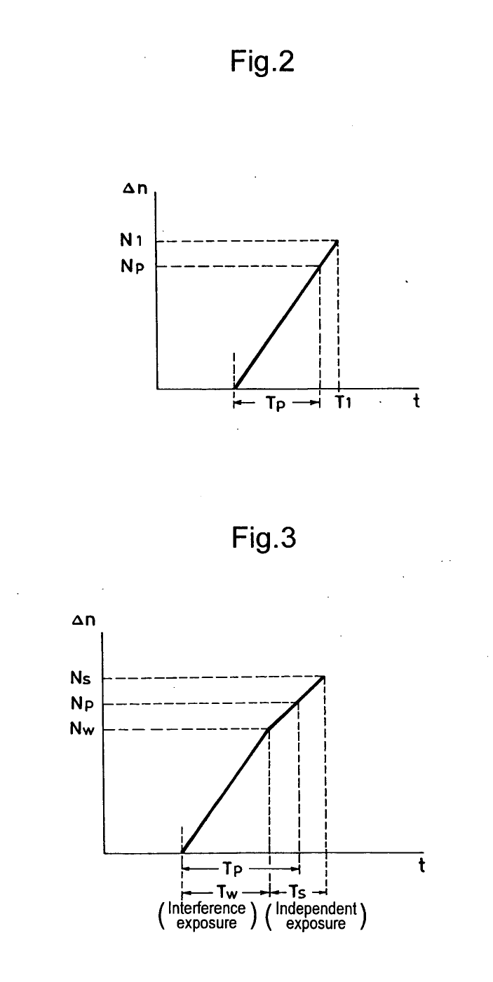

Note that an exposure time T1 of signal light and reference light in a conventional holographic recording method is defined, as shown in FIG. 2, such that a refractive index modulation factor N1 of a hologram is equal to, or greater than, a minimum refractive index modulation factor Np that is necessary for forming a reproducible hologram. That is, the exposure time T1 is set to a value equal to, or greater than, a minimum exposure time Tp corresponding to the minimum refractive index modulation factor Np (T1≧Tp).

On the other hand, an exposure time Tw of signal light and reference light for the interference exposure according to the first embodiment is defined, as shown in FIG. 3, such that a refractive index modulation factor Nw of a hologram is less than. the minimum refractive index modulation factor Np. That is, the exposure time Tw is set to a value less than the minimum exposure time Tp corresponding to the minimum refractive index modulation factor Np (Tw<Tp). Then, in the holographic recording method according to the first embodiment, an interference exposure is completed before the minimum exposure time Tp for forming a reproducible hologram is reached, thereby forming an incomplete hologram.

As a result., when compared with a hologram formed by a conventional holographic recording method, an incomplete hologram formed by the interference exposure of the first embodiment may have more photosensitivity remaining; however, the intensity of the incomplete hologram is amplified by the “independent exposure,” discussed below.

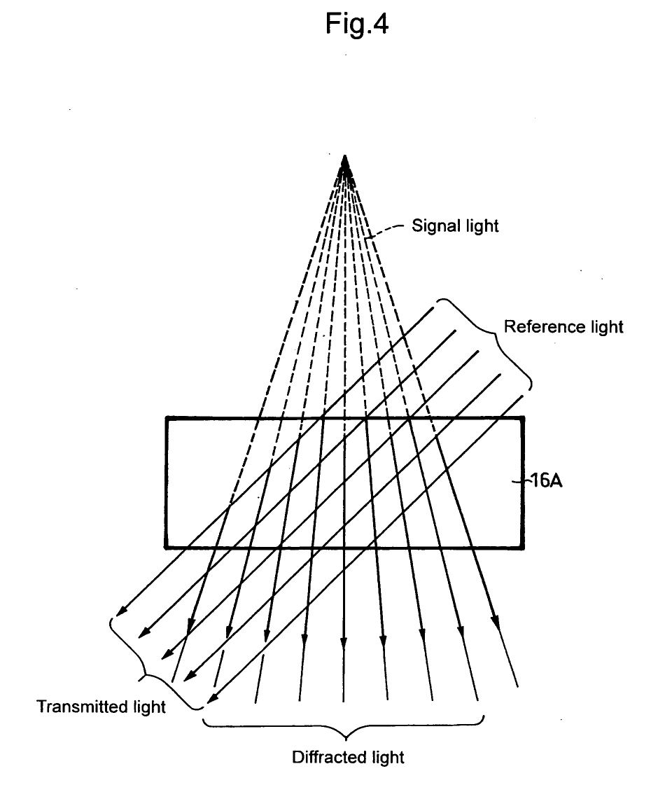

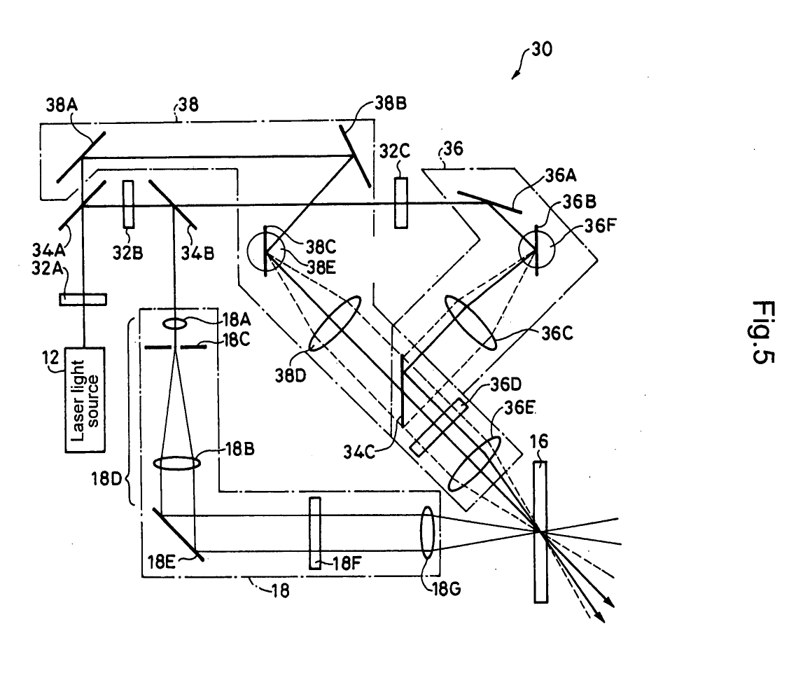

In the independent exposure according to the first embodiment, the optical path of the signal optical system 18 is blocked to irradiate the holographic recording medium 16 only with the reference light. At this time, as shown in FIG. 4, irradiation with the reference light at an incidence angle associated with a reproduced hologram would cause a signal light to be emitted as a diffracted light. However, not the whole of the reference light used for the irradiation is emitted as the diffracted light, but most of it pass through a recording layer 16A of the holographic recording medium 16 as a transmitted light. Then, since the transmitted light and the diffracted light are related to each other in a coherent way (capable of producing interference), an optical interference is produced at an area where they meet, and is recorded in the recording layer 16A as a hologram that has the same shape as that of the incomplete hologram formed by the interference exposure. Accordingly, with photosensitivity remaining in the holographic recording medium 16, an incomplete hologram formed by the “interference exposure” using the signal light and the reference light can be amplified by the “independent exposure” using the reference light (transmitted light) and its diffracted light to form a reproducible hologram. Thus, as shown in FIG. 3, a refractive index modulation factor Ns at the completion of the independent exposure can be made greater than the minimum refractive index modulation factor Np.

According to the holographic recording method of the first embodiment, an interference exposure is completed using signal light and reference light to form an incomplete hologram before the minimum exposure time Tp for forming a reproducible hologram is reached; an independent exposure for irradiating the incomplete hologram with the reference light is performed after the interference exposure to thereby produce diffracted light; and an interference between the reference light and its diffracted light is used to record information. This allows for providing a shortened time for recording and an improved data rate during recording even when the recording material has a lower photosensitivity or the light source has a lower power.

There is a well-known technique generally called as a “post exposure,” which is intended to consume photosensitivity remaining on a recording material after completion of recording. This “post exposure” requires that a reproducible hologram already formed be available at the stage of post exposure, whereas the holographic recording method according to the present invention allows a hologram to have an insufficient intensity at the stage of performing the independent exposure (or allows the hologram to be an incomplete hologram that cannot be reproduced). Thus, the holographic recording method according to the present invention and the “post exposure” are different from each other.

### SECOND EMBODIMENT

Now, a description will be given of a holographic recording method according to a second embodiment of the present invention using a holographic recording apparatus 30 shown in FIG. 5. Note that the portions similar to those of the holographic recording apparatus 10 according to the aforementioned first embodiment will be denoted by the same symbols in the drawings and will not be explained repeatedly.

The holographic recording apparatus 30 is configured to include: a laser light source 12; a polarization beam splitter 34A for splitting laser light into recording light and amplified light, the laser light being emitted from the laser light source 12 and passed through a half-wave plate 32A; a polarization beam splitter 34B for further splitting the recording beam reflected by the polarization beam splitter 34A into signal light and reference light; a signal optical system 18 for introducing s-polarization component reflected from the polarization beam splitter 34B to the holographic recording medium 16; a reference optical system 36 for introducing the s-polarization component, which is transmitted through the polarization beam splitter 34B and which has a polarized plane rotated by about 90 degrees by a half-wave plate 32C, to the holographic recording medium 16; and an amplification optical system 38 for introducing the amplified light or a p-polarization component transmitted through the polarization beam splitter 34A to the holographic recording medium 16. Note that the optical axes of the half-wave plates 32A, 32B, and 32C placed on the optical path are made rotatable so that the intensity of transmitted light or reflected light through the polarization beam splitter 34A or 34B can be adjusted.

The signal optical system 18 is configured to include: a beam expander 18D for expanding the beam diameter of the signal light reflected from the polarization beam splitter 34B; a mirror 18E for reflecting the signal light having passed through the beam expander 18D at a right angle; a SLM 18F upon which the signal light reflected from the mirror 18E is incident; and a Fourier lens 18G for condensing the signal light passed through the SLM 18F into the holographic recording medium 16.

The reference optical system 36 is configured to include: a mirror 36A for reflecting the reference light which is emitted from the polarization beam splitter 34B and has a polarized plane rotated by about 90 degrees by the half-wave plate 32C; a rotary mirror 36B for reflecting the reference light reflected from the mirror 36A to a polarization beam splitter 34C; a lens 36C for condensing the reference light reflected from the rotary mirror 36B onto the polarization beam splitter 34C; and a lens 36E for collimating the reference light, reflected from the polarization beam splitter 34C and passed through a selector 36D, to be made incident on the holographic recording medium 16. Note that the rotary mirror 36A is supported by a rotary stage 36F to provide adjustable angles of reflection, thereby allowing the reference optical system 36 to modulate the incidence angle of the reference light on the holographic recording medium 16. That is, it is possible to perform angle multiplex recording.

The amplification optical system 38 is configured to include: mirrors 38A and 38B for reflecting amplified light transmitted through the polarization beam splitter 34A, in a predetermined direction; a rotary mirror 38C for reflecting the amplified light reflected from the mirror 38B to the polarization beam splitter 34C; a lens 38D for condensing the amplified light reflected from the rotary mirror 38C onto the polarization beam splitter 34C; and the polarization beam splitter 34C, the selector 36D, and the lens 36E which are common to the reference optical system 36. Note that the rotary mirror 38C is supported by a rotary stage 38E to provide adjustable angles of reflection, thereby allowing the amplification optical system 38 to modulate the incidence angle of the amplified light on the holographic recording medium 16.

Note that the signal light and the reference light are applied in an s-polarized state to the holographic recording medium 16, whereas the amplified light is applied in a p-polarized state to the holographic recording medium 16. That is, since the amplified light is “incapable of producing interference” with both the signal light and the reference light, even a simultaneous incidence of the three types of light results in only the interference pattern between the signal light and the reference light being recorded in the holographic recording medium 16.

Now, a description will be given of how to record a hologram by angle multiplex recording using the holographic recording apparatus 30 according to the second embodiment.

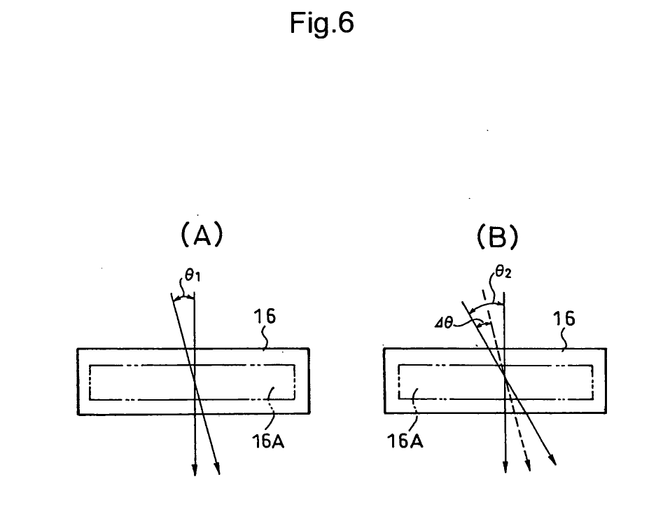

First, as shown in FIG. 6(A), signal light and reference light are irradiated onto the holographic recording medium 16 in a direction orthogonal to the surface thereof and at an angle ⊖₁ with respect to the signal light, respectively, to perform the aforementioned interference exposure, thereby forming an incomplete hologram.

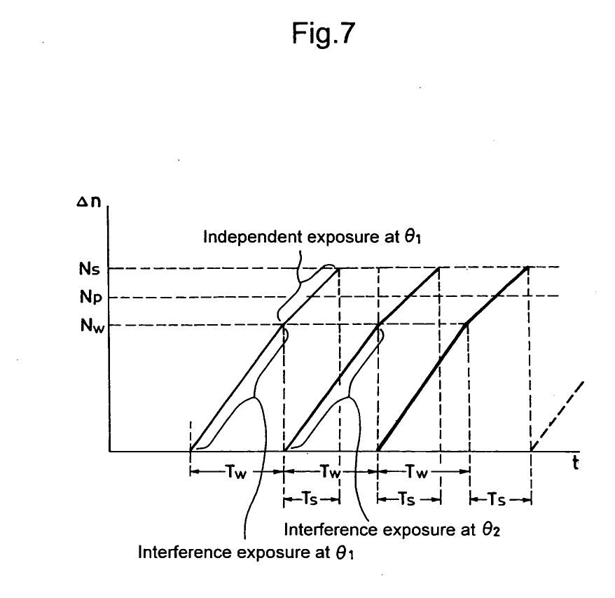

Then, as shown in FIG. 6(B), with the incidence angle of the signal light being fixed, the incidence angle ⊖₁ of the reference light is changed by an angular pitch Δ⊖ into an incidence angle ⊖₂ (=⊖₁+Δ⊖) to perform the interference exposure on the recording layer 16A to form an incomplete hologram. On the other hand, with the incidence angle of the amplified light being adjusted to the incidence angle ⊖₁, which is the same incidence angle condition as that of the reference light, the independent exposure of the incomplete hologram at the incidence angle ⊖₁ is performed in parallel to the interference exposure at the incidence angle ⊖₂, as shown in FIG. 7.

As such, while the incidence angle of the reference light is being varied by the angular pitch Δ⊖, the interference exposure is performed using the signal light and the reference light. At the same time, while the incidence angle of the amplified light is being varied to the incidence angle of the reference light, the independent exposure is performed using the amplified light and its diffracted light to record a required number of pieces of information by angle multiplex recording.

According to the holographic recording method of the second embodiment, an interference exposure is completed using signal light and reference light to form an incomplete hologram before a minimum exposure time for forming a reproducible hologram is reached; an independent exposure for irradiating the incomplete hologram with amplified light is performed after the interference exposure to thereby produce diffracted light, the amplified light being different from the reference light but having the same angle of incidence as that of the reference light; and an interference between the amplified light and its diffracted light is used to record information. Accordingly, this makes it possible to perform the interference exposure and the independent exposure in parallel and provide a further improved data rate during recording.

### THIRD EMBODIMENT

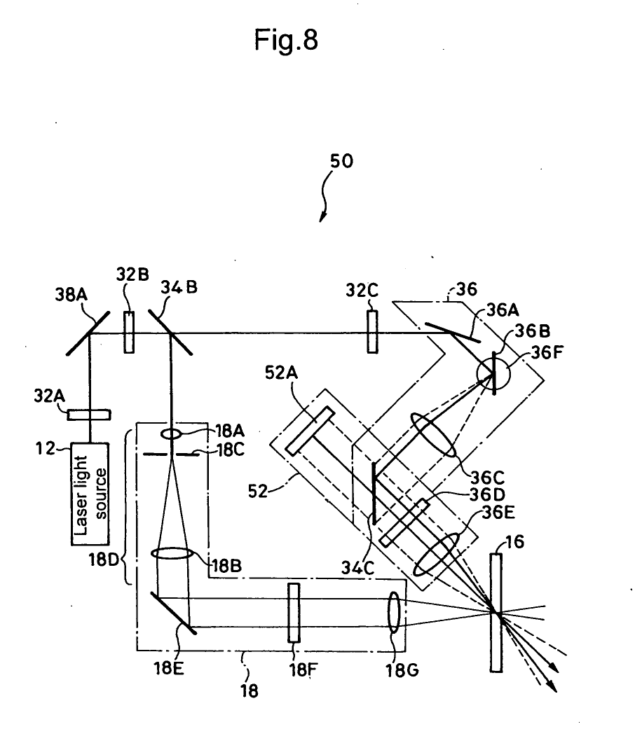

Now, a description will be given of a holographic recording method according to a third embodiment of the present invention using a holographic recording apparatus 50 shown in FIG. 8.

The holographic recording apparatus 50 according to the third embodiment incorporates an amplification optical system 52, which includes a laser diode (LD) array 52A, in place of the amplification optical system 38 of the holographic recording apparatus 30 according to the second embodiment discussed above. Note that the signal optical system 18 and the reference optical system 36 are the same as those of the holographic recording apparatus 30 according to the second embodiment, and thus denoted by the same symbols in the drawing without an explicit explanation thereof.

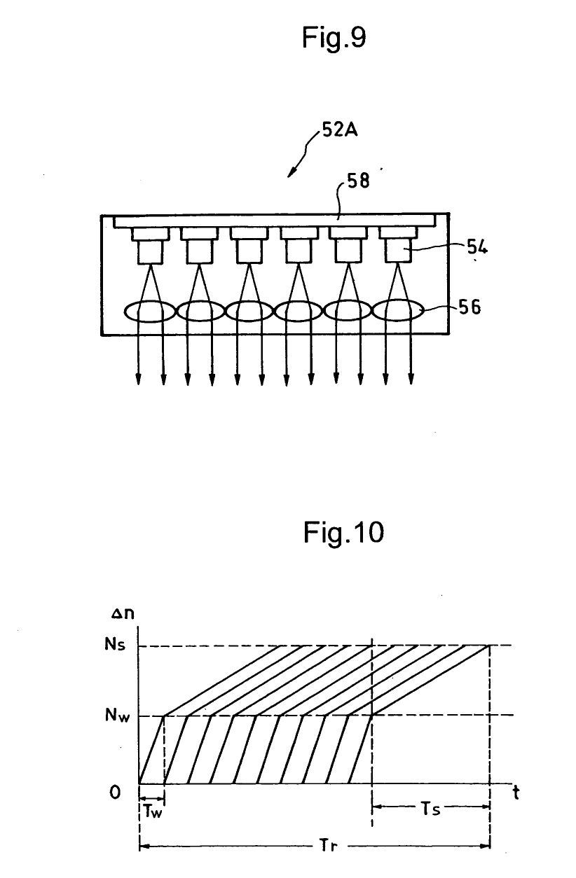

As shown in FIG. 9, the LD array 52A of the amplification optical system 52 is configured to include: a plurality of (six in this example) LDs 54 which can emit laser light incapable of producing interference with each other; collimator lenses 56 which are provided individually to the respective LDs 54; and an LD control board 58 for controlling each of the LDs 54.

FIG. 10 shows an example of recording 10 holograms by angle multiplex recording using the holographic recording apparatus 50. As illustrated, in the holographic recording apparatus 50, an interference exposure is sequentially performed during each exposure time Tw. In parallel to the interference exposure, an independent exposure is performed during an exposure time Ts at the same time on those (five at maximum in this example) incomplete holograms for which the interference exposure has been completed.

According to the holographic recording apparatus 50 of the third embodiment, when a plurality of holograms are sequentially recorded, a plurality of beams of amplified light are used to perform an independent exposure on a plurality of incomplete holograms in parallel, thereby making it possible to provide a further improved data rate during recording.

Furthermore, since the beams of laser light (amplified light) from each of the LDs 54 are incapable of producing interference with each other, an unwanted hologram resulting from an interference between amplified light will never be formed even when a plurality of beams of laser light are emitted simultaneously, thus allowing for preventing occurrence of noise during recording.

Note that the holographic recording method according to the present invention is not limited to the holographic recording method according to the third embodiment, but may also be adapted, for example, to vary the time for the interference exposure or the time for the independent exposure.

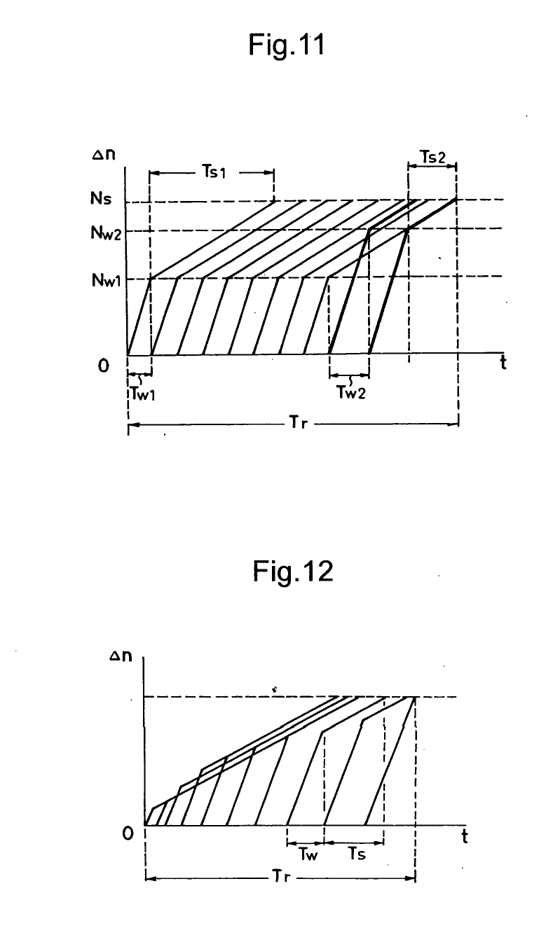

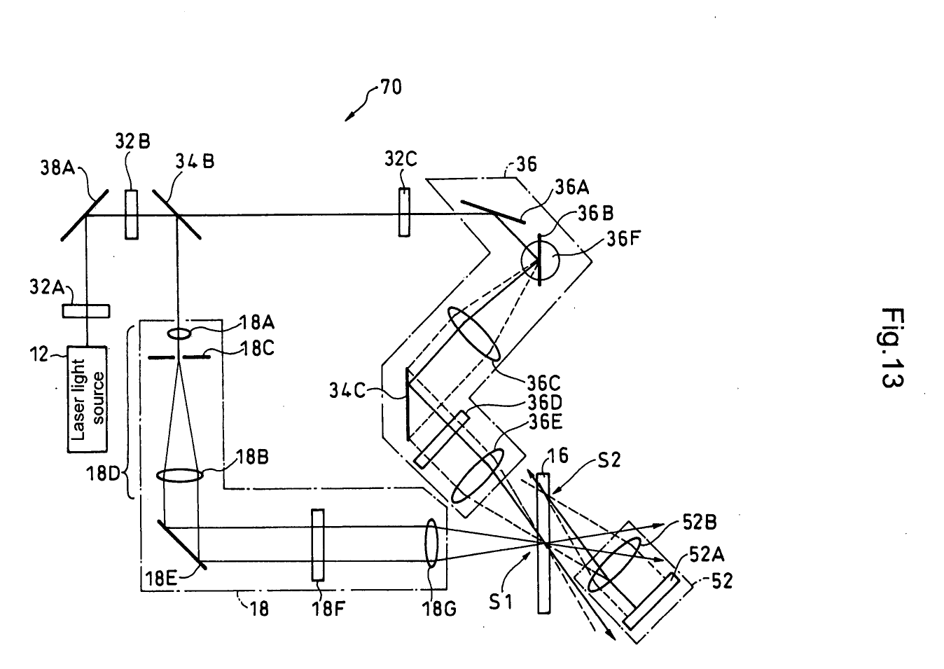

That is, as shown in FIG. 11, when the independent exposure requires a longer exposure time than for the interference exposure, an independent exposure time Ts₁, at which recording starts, may be shortened to Ts₂ at a later stage of recording (at the time of recording the 9th and 10th holograms in this example), thereby making it possible to further shorten a recording time Tr in the holographic recording apparatus. In particular, as shown in FIG. 12, the exposure time Ts for the independent exposure of each incomplete hologram may be decreased in the order in which it is recorded. This makes it possible to enhance the efficiency of scheduling of the interference exposure and the independent exposure, thereby allowing for further reducing the recording time Tr in the holographic recording apparatus.

It is also acceptable to employ a surface emission laser diode in place of the LD array 52A as the light source for a plurality of beams of reference light. Note that the surface emission laser diode is typically fabricated by integrating a few thousands to a few ten thousands of surface emission lasers on one substrate and then cutting them into individual parts, and each surface emission laser emits beams of laser light that are incapable of producing interference with each other.

### FOURTH EMBODIMENT

Now, a description will be given of a holographic recording method according to a fourth embodiment of the present invention using a holographic recording apparatus 70 shown in FIG. 13.

The holographic recording apparatus 70 according to the fourth embodiment is different from the holographic recording apparatus 50 according to the third embodiment described above in that the amplification optical system 52 is placed on an optical path different from that of the reference optical system 36. Note that the other components are the same as those of the holographic recording apparatus 50 according to the third embodiment and thus are denoted by the same symbols in the figure without explicit explanation thereof.

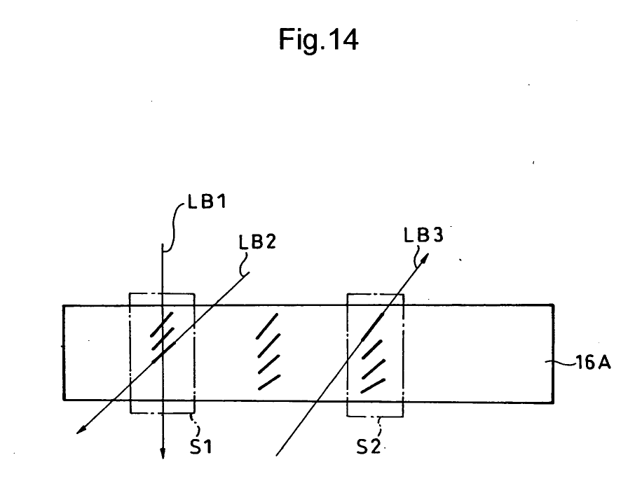

The holographic recording apparatus 70 according to the fourth embodiment is configured such that, as shown in FIG. 14, signal light LB1 of the signal optical system 18 and reference light LB2 of the reference optical system 36 are used to perform an interference exposure in a predetermined area S1, while amplified light LB3 of the amplification optical system 52 is used to perform an independent exposure in another area S2 where an incomplete hologram is present, thereby recording a hologram by angle multiplex recording.

According to the holographic recording method of the fourth embodiment, the interference exposure is performed in the predetermined area S1 of the recording layer 16A, and in parallel to the interference exposure, the independent exposure is performed in the another area S2 where an incomplete hologram is present. This allows for performing the interference exposure and the independent exposure in parallel and providing an improved data rate during recording.

The holographic recording apparatus 70 according to the fourth embodiment is configured such that the LD array 52A serving as the light source in the amplification optical system 52 is separately provided in addition to the laser light source 12 serving as the light source for the signal optical system 18 and the reference optical system 36. However, the present invention is not limited thereto, but may also be configured in the same manner as the holographic recording apparatus 30 according to the second embodiment described above so as to produce amplified light by splitting the laser light source 12. In this case, note that the fourth embodiment is adapted to perform the interference exposure and the independent exposure in different areas, and therefore, unlike the second embodiment discussed above, both the s-polarization and the p-polarization or both the right-handed and left-handed elliptical polarizations can be each used as amplified light. Thus, this makes it possible to use two types of light to perform an independent exposure of two incomplete holograms at the same time.

Furthermore, the area where the interference exposure is performed and the area where the independent exposure is performed are only required to be different from each other, and may be thus adjacent to each other.

Note that in the first to fourth embodiments described above, such an example has been shown in which the exposure time and the refractive index modulation factor are linearly related to each other. However, the present invention is not limited thereto, but the holographic recording method of the present invention may also be employed according to the property of the photosensitive material of the recording layer.

### INDUSTRIAL APPLICABILITY

The holographic recording method and the holographic recording apparatus according to the present invention make it possible to provide a shortened time for recording and an improved data rate during recording even when the recording material has a low photosensitivity or the light source has a low power.

1. A holographic recording method for recording information in a recording layer as a hologram by means of interference fringes between signal light and reference light branched out from laser light, the method comprising: before a minimum exposure time for forming a reproducible hologram is reached, completing an interference exposure using the signal light and the reference light to form an incomplete hologram; performing an independent exposure for irradiating the incomplete hologram with the reference light after the interference exposure to thereby produce diffracted light; and recording the information by means of interference between the reference light and the diffracted light.

2. A holographic recording method for recording information in a recording layer as a hologram by means of interference fringes between signal light and reference light branched out from laser light, the method comprising: before a minimum exposure time for forming a reproducible hologram is reached, completing an interference exposure using the signal light and the reference light to form an incomplete hologram; performing an independent exposure for irradiating the incomplete hologram with amplified light after the interference exposure to thereby produce the diffracted light, the amplified light being different from the reference light and having the same incidence angle as that of the reference light; and the interference between the amplified light and the diffracted light is used to record the information.

3. The holographic recording method according to claim 2, wherein
when a plurality of the holograms are sequentially recorded, a plurality of beams of amplified light are used to perform the independent exposures in parallel on a plurality of the incomplete holograms.

4. The holographic recording method according to claim 3, wherein
the incomplete holograms are subjected to independent exposure with an exposure time which is decreased in an order in which the incomplete holograms are recorded.

5. The holographic recording method according to claim 3, wherein
the plurality of beams of amplified light are incapable of producing interference with each other.

6. The holographic recording method according to claim 4, wherein
the plurality of beams of amplified light are incapable of producing interference with each other.

7. The holographic recording method according to claim 3, wherein
a light source of the plurality of beams of amplified light is formed of either a laser array having a plurality of laser diodes or a surface emission laser diode.

8. The holographic recording method according to claim 3, wherein
the interference exposure is performed in a predetermined area in the recording layer, and along with the interference exposure, the independent exposure is performed in another area where the incomplete hologram is present.

9. The holographic recording method according to claim 4, wherein
the interference exposure is performed in a predetermined area in the recording layer, and along with the interference exposure, the independent exposure is performed in another area where the incomplete hologram is present.

10. A holographic recording apparatus capable of recording information in a recording layer as a hologram by means of interference fringes between signal light and reference light branched out from laser light, the holographic recording apparatus comprising a signal optical system and a reference optical system, in which before a minimum exposure time for forming a reproducible hologram is reached, an interference exposure is completed using the signal light and the reference light to form an incomplete hologram; an independent exposure for irradiating the incomplete hologram with the reference light is performed after the interference exposure to thereby produce diffracted light; and a intensity of the incomplete hologram can be amplified by means of interference between the reference light and the diffracted light.

11. A holographic recording apparatus capable of recording information in a recording layer as a hologram by means of interference fringes between signal light and reference light branched out from laser light, the holographic recording apparatus comprising a signal optical system and a reference optical system, in which before a minimum exposure time for forming a reproducible hologram is reached, an interference exposure is completed using the signal light and the reference light to form an incomplete hologram; and
an amplification optical system capable of performing the independent exposure by irradiating the incomplete hologram with amplified light after the interference exposure to thereby produce diffracted light, the amplified light being different from the reference light and having the same incidence angle as that of the reference light; and using the interference between the amplified light and the diffracted light to amplify a intensity of the incomplete hologram.

12. The holographic recording apparatus according to claim 11, wherein
when a plurality of the holograms are sequentially recorded, a plurality of beams of amplified light are used to perform the independent exposures in parallel on a plurality of the incomplete holograms.

13. The holographic recording apparatus according to claim 12, wherein
the amplification optical system is comprised so that the incomplete holograms are subjected to independent exposure with an exposure time which is decreased in an order in which the incomplete holograms are recorded.

14. The holographic recording apparatus according to claim 12, wherein p1 the plurality of beams of amplified light are incapable of producing interference with each other.

15. The holographic recording apparatus according to claim 13, wherein
the plurality of beams of amplified light are incapable of producing interference with each other.

16. The holographic recording apparatus according to claim 12, wherein
a light source of the plurality of beams of amplified light is formed of either a laser array having a plurality of laser diodes or a surface emission laser diode.

17. The holographic recording apparatus according to claim 11, wherein
the signal optical system and the reference optical system are used to perform the interference exposure in a predetermined area in the recording layer, and along with the interference exposure, the amplification optical system is used to perform the independent exposure in another area in which the incomplete hologram is present.

18. The holographic recording apparatus according to claim 12, wherein
the signal optical system and the reference optical system are used to perform the interference exposure in a predetermined area in the recording layer, and along with the interference exposure, the amplification optical system is used to perform the independent exposure in another area in which the incomplete hologram is present.
